(19) United States
(12) Patent Application Publication
(10) Pub. No.: US 2026/0143455 A1
(43) Pub. Date: May 21, 2026

(54) SYSTEMS, METHODS, AND NON-TRANSITORY COMPUTER-READABLE MEDIA FOR IDENTIFYING A-IOT DEVICES

(71) Applicant: ZTE CORPORATION, Shenzhen (CN)

(72) Inventors: Rongwei SHI, Shenzhen (CN); Chuangxin JIANG, Shenzhen (CN); Bo DAI, Shenzhen (CN); Cong WANG, Shenzhen (CN); Focai PENG, Shenzhen (CN); Junpeng LOU, Shenzhen (CN)

(73) Assignee: ZTE CORPORATION, Shenzhen (CN)

(21) Appl. No.: 19/443,786

(22) Filed: Jan. 8, 2026

Related U.S. Application Data
(63) Continuation of application No. PCT/CN2023/114712, filed on Aug. 24, 2023.

(51) Int. Cl. H04W 64/00; H04L 27/02; H04W 76/20; H04W 92/18

(52) U.S. Cl. CPC H04W 64/00; H04L 27/02; H04W 76/20; H04W 92/18

(57) ABSTRACT

The present disclosure relates to systems, apparatuses, methods, and non-transitory computer-readable media for receiving, by a network function from each of a plurality of Base Stations (BSs), transmit signal configuration for a signal transmitted by each of the plurality of BSs to a respective one of a plurality of Ambient power-enabled Internet of Things (A-IoT) devices, sending, by the network function, a transmit signal configuration list comprising the transmit signal configuration received from each of the plurality of BSs; and sending, to at least one of the plurality of A-IoT devices, backscatter configuration indicating a mapping relationship between the signal received by the at least one of the plurality of A-IoT devices and a backscatter reflected by the at least one of the plurality of A-IoT devices.

### CROSS-REFERENCE TO RELATED APPLICATION

This application claims the benefit of priority under 35 U.S.C. § 120 as a continuation of PCT Patent Application No. PCT/CN2023/114712, filed on Aug. 24, 2023, the disclosure of which is incorporated herein by reference in its entirety.

### TECHNICAL FIELD

The disclosure relates generally to wireless communications, and in particular to systems, methods, and non-transitory computer-readable media for identifying Ambient power-enabled Internet of Things (A-IoT) devices.

### BACKGROUND

A-IoT devices utilize environment energy harvesting and backscattering technology to maintain self-operation and deliver information to other devices. As power supply modules are not needed, A-IoT technology has promising research prospect and widespread application. However, for the ultra-low power consumption and complexity, conventional technology cannot recognize different A-IoT devices from a long distance (e.g., more than 100 m) away.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media for receiving, by a network function from each of a plurality of Base Stations (BSs), transmit signal configuration for a signal transmitted by each of the plurality of BSs to a respective one of a plurality of Ambient power-enabled Internet of Things (A-IoT) devices, sending, by the network function, a transmit signal configuration list comprising the transmit signal configuration received from each of the plurality of BSs; and sending, to at least one of the plurality of A-IoT devices, backscatter configuration indicating a mapping relationship between the signal received by the at least one of the plurality of A-IoT devices and a backscatter reflected by the at least one of the plurality of A-IoT devices.

Some arrangements of the present disclosure relate to systems, methods, apparatuses, and non-transitory computer-readable media for sending, by a Base Station (BS) to a network function, transmit signal configuration for a signal transmitted by the BS to a respective one of a plurality of Ambient power-enabled Internet of Things (A-IoT) devices, receiving, by the BS, a transmit signal configuration list comprising the transmit signal configuration received from each of a plurality of BSs; and, sending, by the BS to at least one of the plurality of A-IoT devices, backscatter configuration indicating a mapping relationship between the signal received by the at least one of the plurality of A-IoT devices and a backscatter reflected by the at least one of the plurality of A-IoT devices.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a flowchart diagram illustrating an example method for configuring backscatter by A-IoT devices, according to various arrangements.

FIG. 1B is a flowchart diagram illustrating an example method for configuring backscatter by A-IoT devices, according to various arrangements.

FIG. 2 is a signaling diagram illustrating an example method for configuring communications of an A-IoT device, according to various arrangements.

FIG. 3 is a signaling diagram illustrating an example method for configuring communications of an A-IoT device, according to various arrangements.

FIG. 4 is a signaling diagram illustrating an example method for configuring communications of an A-IoT device, according to various arrangements.

FIG. 5 is a signaling diagram illustrating an example method for configuring communications of an A-IoT device, according to various arrangements.

FIG. 6 is a signaling diagram illustrating an example method for configuring communications of an A-IoT device, according to various arrangements.

FIG. 7 is a signaling diagram illustrating an example method for configuring communications of an A-IoT device, according to various arrangements.

FIG. 8 is a signaling diagram illustrating an example method for configuring communications of an A-IoT device, according to various arrangements.

FIG. 9 is a diagram illustrating reflected signals in a spatial aspect (e.g., in a spatial domain), according to various arrangements.

FIG. 10 is a diagram illustrating A-IoT devices receiving the transmitted signal and reflect as reflected signal (backscatter) at different times configured by the reflection signal resource configuration parameter in a reflection time method, according to various arrangements.

FIG. 11 is a diagram illustrating reflected signals a frequency domain for identifying A-IoT devices using center frequency shifting, according to various arrangements.

FIG. 12 is a diagram illustrating an example carrier space for center frequency shifting, according to various arrangements.

FIG. 13 is a diagram illustrating reflected signals in a code domain for identifying A-IoT devices using OOK code method, according to various arrangements.

FIG. 14 is a diagram illustrating a joint processing method based on the time domain and the spatial domain, according to various arrangements.

FIG. 15 is a diagram illustrating an example method for configuring communication and positioning reflection parameters separately, according to various arrangements.

FIG. 16 is a diagram illustrating an example method for configuring communication and positioning reflection parameters separately, according to various arrangements.

FIG. 17 is a signaling diagram illustrating an example method for configuring communications of an A-IoT device, according to various arrangements.

FIG. 18 illustrates a block diagram of an example BS and an example UE, according to various arrangements.

FIG. 19 illustrates block diagram of example A-IoT devices, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

According to the energy storage capacity, A-IoT devices are classified as various types, e.g., Type A, Type B, Type C, and so on. A Type A A-IoT device has no energy storage and no independent signal generation/amplification. For example, a Type A A-IoT device uses backscattering transmission and can be called a passive IoT device. A Type B A-IoT device has energy storage and no independent signal generation. For example, a Type B A-IoT device uses backscattering transmission. The use of stored energy can include amplification for reflected signals. A Type B A-IoT device can also be called a semi-passive IoT device. A Type C A-IoT device has energy storage and independent signal generation (e.g., active RF components for transmission). A Type C A-IoT device can also be called an active IoT device.

Conventionally, A-IoT devices use Radio Frequency Identification (RFID), typically used in low power-consumption devices, as the recognition method. As a short-distance communication method, RFID can support 1-10 m recognition distances and various frequency ranges, such as 125 KHz, 13.54 MHz, 850 MHz-910 MHz, and 2.45 GHz. By utilizing inductive coupling, RFID devices can receive energy from the transmitting carrier and use non-powered tag to achieve object identification, which is widely used in transportation and logistics management. Existing RFID technology requires a reader/writer equipment to send inventory command point to point, which not only severely limits the recognition distance but is also not applicable in outdoor scenarios. Furthermore, due to limitation to the memory capacity of tags, a large number of tags for identifying A-IoT devices can be costly and burdensome to implement.

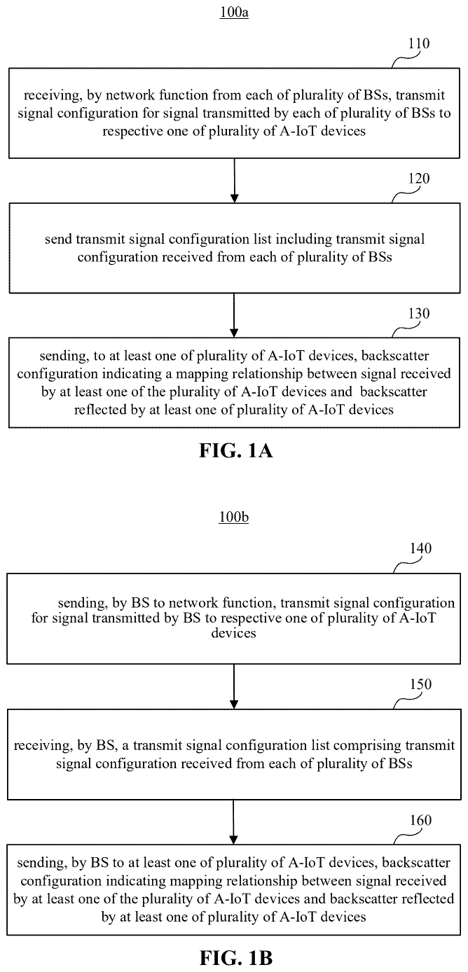

The arrangements disclosed herein relate to cellular network architecture for A-IoT identification. FIG. 1A is a flowchart diagram illustrating an example method 100a for configuring backscatter by A-IoT devices, according to various arrangements. The method 100a can be performed by a network function (e.g., an LMF) according to various arrangements.

At 110, the network function receives from each of a plurality of BSs, transmit signal configuration for a signal transmitted by each of plurality of BSs to respective one of plurality of A-IoT devices. At 120, the network function sends a transmit signal configuration list includes the transmit signal configuration received from each of the plurality of BSs. At 130, the network function sends to at least one of the plurality of A-IoT devices, backscatter configuration indicating a mapping relationship between the signal received by the at least one of the plurality of A-IoT devices and a backscatter reflected by the at least one of the plurality of A-IoT devices.

FIG. 1B is a flowchart diagram illustrating an example method 100b for configuring backscatter by A-IoT devices, according to various arrangements. The method 100b can be performed by a BS according to various arrangements.

At 140, the BS sends to a network function (e.g., an LMF), transmit signal configuration for a signal transmitted by the BS to a respective one of a plurality of A-IoT devices. At 150, the BS receives a transmit signal configuration list including the transmit signal configuration received from each of a plurality of BSs. At 160, the BS sends to at least one of the plurality of A-IoT devices, backscatter configuration indicating a mapping relationship between the signal received by the at least one of the plurality of A-IoT devices and a backscatter reflected by the at least one of the plurality of A-IoT devices.

In a communication process, several Transmission and Reception Points (TRPs) transmit signals to potential A-IoT devices. The A-IoT devices reflect the received signal with simple processing. If the A-IoT devices using the same processing method for different receiving signals, the BS cannot distinguish which A-IoT device reflects the received signals. Some arrangements relate to distinguishing the reflection parameters of different A-IoT devices for a BS, an LMF, or UE. Several example identification flows for the reflection parameters dedicated for different A-IoT devices are described herein. Each or each set of reflection parameters is associated with a UE ID.

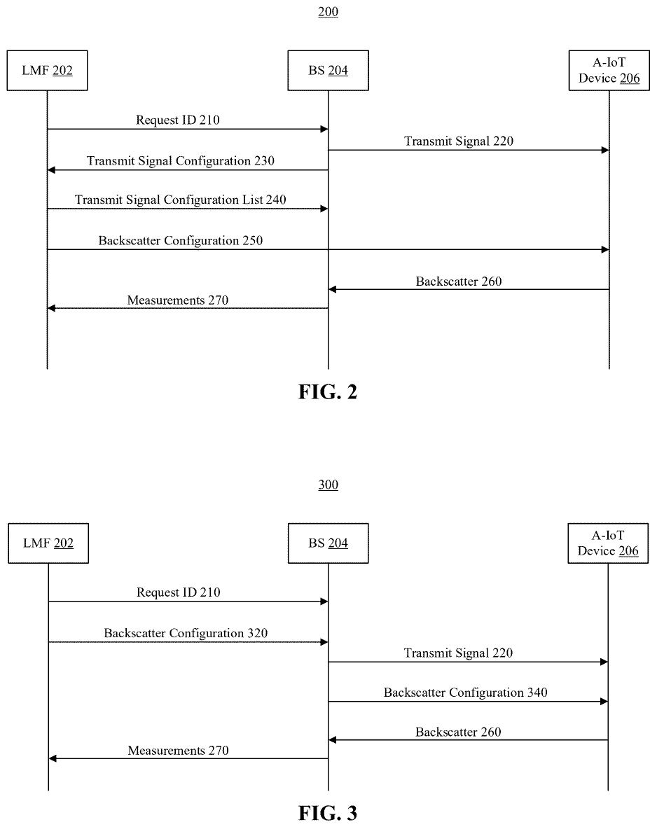

FIG. 2 is a signaling diagram illustrating an example method 200 for configuring communications of an A-IoT device 206, according to various arrangements. While FIG. 2 shows one BS 204 and one A-IoT device 206, the method 200 can be implemented for multiple BSs (each of which can be the BS 204) and A-IoT devices (each of which can be the A-IoT device 206). The method 200 relates to reflection parameters configured by the LMF 202. That is, FIG. 2 is an identification flow in which the reflection parameters are configured by the LMF 202 and sent to the A-IoT device 206 directly.

At 210, the LMF 202 sends a request ID message to each of a plurality of BSs (e.g., the BS 204). The request ID message can be included in an Assistance Information Information Element (IE) in a New Radio Positioning Protocol A (NRPPa) message. At 220, each of the plurality of BSs (e.g., the BS 204) transmits a signal (e.g., a measurement signal or a signal to be measured) to each of a plurality of A-IoT devices (e.g., the A-IoT device 206). At 230, each of the plurality of BSs (e.g., the BS 204) transmits a time/frequency configuration of the transmitted signal (e.g., transmitted at 220) to the LMF 202.

At 240, the LMF 202 collects the configuration of all transmitted signals (for the plurality of BSs and A-IoT devices) and sends a transmit signal configuration list to each of the plurality of BSs (e.g., the BS 204). The transmit signal configuration list includes the configuration of signal sent by BSs other than the BS 204. Furthermore, at 250, the LMF 202 can send the backscatter configuration to the plurality of A-IoT devices (including the A-IoT device 206). The backscatter configuration can indicate a mapping relationship between the received signal (e.g., received at 220 by the A-IoT device 206) and the backscatter (e.g., the reflected signal).

In some examples, the backscatter configuration (e.g., at 250) can include reflection parameters such as a transmitting signal (e.g., time/frequency) resource configuration parameter, reflection signal (e.g., spatial/time/frequency/code) resource configuration parameter, and another suitable parameter. In some arrangements, the backscatter configuration can be included in a Long Term Evolution Positioning Protocol (LPP) message. In some examples, the backscatter configuration can be included in Assistance Data.

At 260, the A-IoT device 206 can send the backscatter (e.g., the reflected signal) to the BS 204. A Type A A-IoT device reflects or sends the backscatter immediately in response to receiving the signal at 220. A Type B or Type C A-IoT device stores the receiving signal energy of the signal received at 220 and reflects or sends the backscatter in response to the device reaching its own energy threshold. The reflected signal is processed by the BS 204 according to the reflection signal (e.g., spatial/time/frequency/code) resource configuration parameter.

At 270, the BS 204 sends to the LMF 202 the measurements of the backscatter (e.g., the reflected signal). The LMF 202 receives measurements from multiple BSs (including the BS 204) and estimates the position for different A-IoT devices (including the A-IoT device 206) according to positioning methods such as Time Difference Of Arrival (TDOA), Round Trip Time (RTT), Carrier Phase Positioning (CPP), and so on.

FIG. 3 is a signaling diagram illustrating an example method 300 for configuring communications of an A-IoT device 206, according to various arrangements. While FIG. 3 shows one BS 204 and one A-IoT device 206, the method 300 can be implemented for multiple BSs (each of which can be the BS 204) and A-IoT devices (each of which can be the A-IoT device 206). The method 300 relates to reflection parameters configured by the LMF 202. That is, FIG. 3 is an identification flow in which the reflection parameters are configured by the LMF 202 and sent to the A-IoT device 206 indirectly via the BS 204.

As described with respect to FIG. 2, at 210, the LMF 202 sends a request ID message to each of a plurality of BSs (e.g., the BS 204). At 320, the LMF 202 can send the backscatter configuration to the plurality of BSs (e.g., the BS 204) via an NRPPA message. As described with respect to FIG. 2, at 220, each of the plurality of BSs (e.g., the BS 204) transmits a signal (e.g., a measurement signal or a signal to be measured) to each of a plurality of A-IoT devices (e.g., the A-IoT device 206). At 340, each of the plurality of BSs (e.g., the BS 204) transmits the backscatter configuration to each of a plurality of A-IoT devices (e.g., the A-IoT device 206) via a Radio Resource Control (RRC) message.

As described with respect to FIG. 2, at 260, the A-IoT device 206 can send the backscatter (e.g., the reflected signal) to the BS 204. As described with respect to FIG. 2, at 270, the BS 204 sends to the LMF 202 the measurements of the backscatter (e.g., the reflected signal).

In some examples, the backscatter configuration at 320 and 340 can include reflection parameters such as all transmit signal (time/frequency) resource configuration parameter, a reflection signal (e.g., spatial/time/frequency/code) resource configuration parameter, or another suitable parameter.

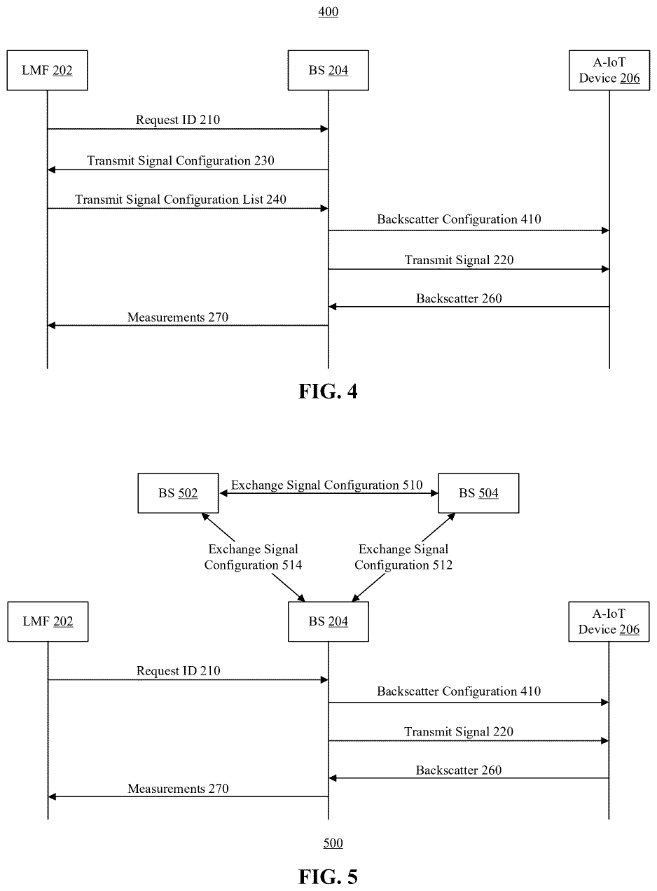

FIG. 4 is a signaling diagram illustrating an example method 400 for configuring communications of an A-IoT device 206, according to various arrangements. While FIG. 4 shows one BS 204 and one A-IoT device 206, the method 400 can be implemented for multiple BSs (each of which can be the BS 204) and A-IoT devices (each of which can be the A-IoT device 206). The method 400 relates to reflection parameters configured by the BS 204. That is, FIG. 4 is an identification flow in which the reflection parameters are configured by the BS 204 and sent to the A-IoT device 206.

As described with respect to FIG. 2, at 210, the LMF 202 sends a request ID message to each of a plurality of BSs (e.g., the BS 204). As described with respect to FIG. 2, at 230, each of the plurality of BSs (e.g., the BS 204) transmits a time/frequency configuration of the transmitted signal (e.g., to be transmitted at 220) to the LMF 202. As described with respect to FIG. 2, at 240, the LMF 202 collects the configuration of all transmitted signals (for the plurality of BSs and A-IoT devices) and sends a transmit signal configuration list to each of the plurality of BSs (e.g., the BS 204).

In response to receiving the transmit signal configuration list, each BS (e.g., the BS 204) determines the backscatter configuration which is applicable to the cell that the BS covers. At 410, each BS (e.g., the BS 204) sends the backscatter configuration to potential A-IoT devices (e.g., the A-IoT device 206).

As described with respect to FIG. 2, at 220, each of the plurality of BSs (e.g., the BS 204) transmits a signal (e.g., a measurement signal or a signal to be measured) to each of a plurality of A-IoT devices (e.g., the A-IoT device 206). As described with respect to FIG. 2, at 260, the A-IoT device 206 can send the backscatter (e.g., the reflected signal) to the BS 204. As described with respect to FIG. 2, at 270, the BS 204 sends to the LMF 202 the measurements of the backscatter (e.g., the reflected signal).

FIG. 5 is a signaling diagram illustrating an example method 500 for configuring communications of an A-IoT device 206, according to various arrangements. While FIG. 5 shows 3 BSs 204, 502, and 504 and one A-IoT device 206, the method 500 can be implemented for four or more BSs (each of which can be the BS 204, 502, or 504) and multiple A-IoT devices (each of which can be the A-IoT device 206). The method 500 relates to reflection parameters configured by the BS 204. That is, FIG. 5 is an identification flow in which the reflection parameters are configured by the BS 204 and sent to the A-IoT device 206.

As described with respect to FIG. 2, at 210, the LMF 202 sends a request ID message to each of a plurality of BSs (e.g., the BSs 204, 502, and 504). At 510, 512, and 514, the plurality of BSs (e.g., the BSs 204, 502, and 504) can exchange among themselves a time/frequency configuration of the transmitted signal (e.g., to be transmitted at 220), without routing to the LMF 202. Each of the plurality of BSs can obtain the configuration of all transmitted signals (for the plurality of BSs and A-IoT devices) through the exchange of such information at 510, 512, and 514.

In response to determining the configuration of all transmitted signals through the exchange of such information, each BS (e.g., the BS 204) determines the backscatter configuration which is applicable to the cell that the BS covers. At 410, each BS (e.g., the BS 204) sends the backscatter configuration to potential A-IoT devices (e.g., the A-IoT device 206).

As described with respect to FIG. 2, at 220, each of the plurality of BSs (e.g., the BS 204) transmits a signal (e.g., a measurement signal or a signal to be measured) to each of a plurality of A-IoT devices (e.g., the A-IoT device 206). As described with respect to FIG. 2, at 260, the A-IoT device 206 can send the backscatter (e.g., the reflected signal) to the BS 204. As described with respect to FIG. 2, at 270, the BS 204 sends to the LMF 202 the measurements of the backscatter (e.g., the reflected signal).

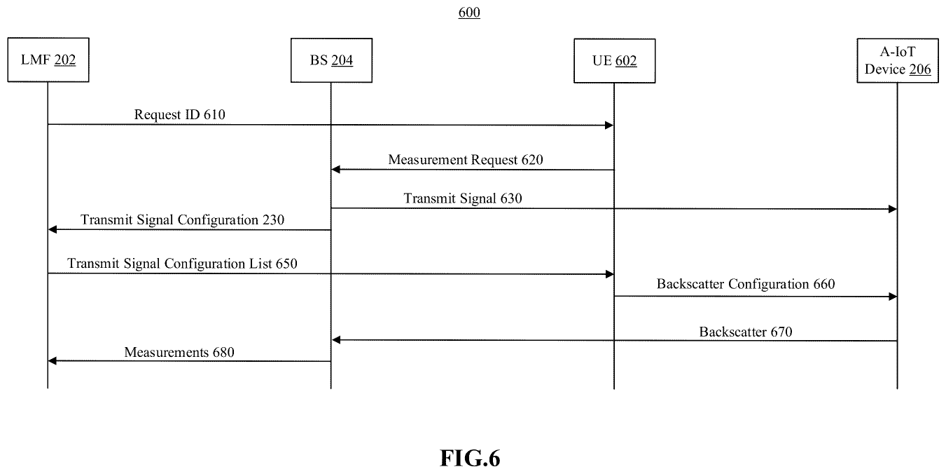

FIG. 6 is a signaling diagram illustrating an example method 600 for configuring communications of an A-IoT device 206, according to various arrangements. While FIG. 6 shows one BS 204, one UE 602, and one A-IoT device 206, the method 600 can be implemented for multiple BSs (each of which can be the BS 204), multiple UEs (each of which can be the UE 602), and multiple A-IoT devices (each of which can be the A-IoT device 206). The method 600 relates to reflection parameters configured by an assistant node such as a UE 602. That is, FIG. 6 is an identification flow in which the reflection parameters are configured by the UE 602 and sent to the A-IoT device 206. The UE 602 has the ability of designing the reflection signal (time/frequency/code/phase) resource configuration parameter independently. The UE 602 can provide an assistance/anchor position for the A-IoT devices.

At 610, the LMF 202 sends a request ID message to each of a plurality UEs (e.g., the UE 602). The request ID message can be included in an Assistance Information IE in a NRPPa message. At 620, the UE 602 sends a measurement request to the BS 204. In response to the measurement request, at 630, each of the plurality of BSs (e.g., the BS 204) transmits a signal (e.g., a measurement signal or a signal to be measured) to each of a plurality of A-IoT devices (e.g., the A-IoT device 206).

At 230, each of the plurality of BSs (e.g., the BS 204) transmits a time/frequency configuration of the transmitted signal (e.g., transmitted at 220) to the LMF 202. At 650, the LMF 202 collects the configuration of all transmitted signals (for the plurality of BSs and A-IoT devices) and sends a transmit signal configuration list to each of the plurality of UEs (e.g., the UE 602). The transmit signal configuration list includes the configuration of signal sent by BSs other than the BS 204.

At 660, the plurality of UEs (e.g., the UE 602) can send the backscatter configuration to the plurality of A-IoT devices (including the A-IoT device 206) via sidelinks between the UEs and the A-IoT devices. The backscatter configuration can indicate a mapping relationship between the received signal and the backscatter (e.g., the reflected signal). In some arrangements, the backscatter configuration sent to A-IoT devices by the UEs can include reflection parameters such as a transmit Positioning Reference Signal (PRS) (time/frequency) resource configuration parameter, a reflection signal (spatial/time/frequency/code) resource configuration parameter, an assistance UE ID of each respective UE, an assistance UE position of each respective UE, or another suitable parameter. The assistance UE ID is a tag for the respective UE. The assistance UE position provides the anchor position for the A-IoT devices.

At 670, the A-IoT device 206 can send the backscatter (e.g., the reflected signal) to the BS 204. At 680, the BS 204 sends to the LMF 202 the measurements of the backscatter (e.g., the reflected signal).

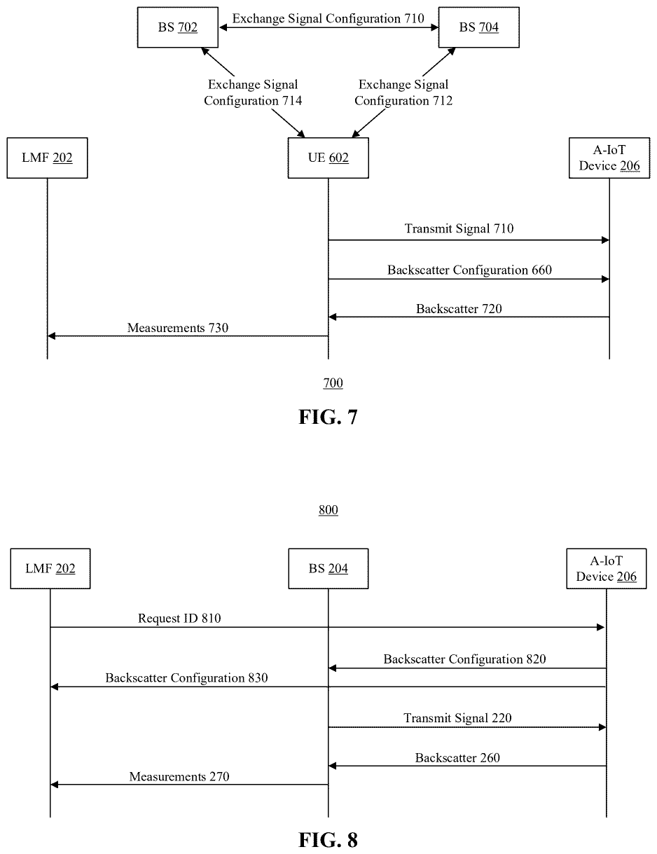

FIG. 7 is a signaling diagram illustrating an example method 700 for configuring communications of an A-IoT device 206, according to various arrangements. While FIG. 7 shows 3 UEs 602, 702, and 704 and one A-IoT device 206, the method 700 can be implemented for multiple UEs (each of which can be the UEs 602, 702, and 704) and multiple A-IoT devices (each of which can be the A-IoT device 206). The method 700 relates to reflection parameters configured by the UE 602. That is, FIG. 7 is an identification flow in which the reflection parameters are configured by the UE 602 (without the LMF 202 or a BS) and sent to the A-IoT device 206.

At 710, 712, and 714, the plurality of UEs (e.g., the UEs 602, 702, and 704) can exchange among themselves a time/frequency configuration of the transmitted signal (e.g., to be transmitted at 710), without routing to the LMF 202 or a BS. Each of the plurality of UEs can obtain the configuration of all transmitted signals (for the plurality of UEs and A-IoT devices) through the exchange of such information at 710, 712, and 714.

In response to determining the configuration of all transmitted signals through the exchange of such information, each UE (e.g., the UE 602) transmits the signal at 710. At 660, the plurality of UEs (e.g., the UE 602) can send the backscatter configuration to the plurality of A-IoT devices (including the A-IoT device 206) via sidelinks between the UEs and the A-IoT devices.

At 720, the A-IoT device 206 can send the backscatter (e.g., the reflected signal) to the UE 602. At 730, the UE 602 sends to the LMF 202 the measurements of the backscatter (e.g., the reflected signal).

FIG. 8 is a signaling diagram illustrating an example method 800 for configuring communications of an A-IoT device 206, according to various arrangements. While FIG. 8 shows one BS 204 and one A-IoT device 206, the method 800 can be implemented for multiple BSs (each of which can be the BS 204) and A-IoT devices (each of which can be the A-IoT device 206). The method 800 relates to reflection parameters reported by the A-IoT device 206. The A-IoT devices (e.g., the A-IoT device 206) has the ability to generate and report signal independently. Therefore the A-IoT devices in FIG. 8 are Type C A-IoT devices.

At 810, the LMF 202 sends a request ID message to each of a plurality of A-IoT devices (e.g., the A-IoT device 206). At 820, each of the plurality of A-IoT devices (e.g., the A-IoT device 206) transmits or reports the backscatter configuration to each of the plurality of BSs (e.g., the BS 204) using RRC messages. At 830, each of the plurality of A-IoT devices (e.g., the A-IoT device 206) transmits or reports the backscatter configuration to each of the LMF 202 using LPP messages.

As described with respect to FIG. 2, at 220, each of the plurality of BSs (e.g., the BS 204) transmits a signal (e.g., a measurement signal or a signal to be measured) to each of a plurality of A-IoT devices (e.g., the A-IoT device 206). As described with respect to FIG. 2, at 260, the A-IoT device 206 can send the backscatter (e.g., the reflected signal) to the BS 204. As described with respect to FIG. 2, at 270, the BS 204 sends to the LMF 202 the measurements of the backscatter (e.g., the reflected signal).

In some examples, the backscatter configuration at 820 can include reflection parameters such as a transmit signal (time/frequency) resource configuration parameter, a reflection signal (e.g., spatial/time/frequency/code) resource configuration parameter, or another suitable parameter. In some examples, the backscatter configuration at 830 can include a reflection signal (e.g., spatial/time/frequency/code) resource configuration parameter, an assistance A-IoT ID, or another suitable parameter. The assistance IoT ID is an assistance tag transmitted by the A-IoT device 206 which is stored in the A-IoT device EX-factory. Thus, the Backscatter Configuration parameters sent to LMF and gNB are different.

In some examples, the backscatter configuration includes a reflection parameter configured by the network function for different ones of the plurality of A-IoT devices. The backscatter configuration is sent by the network function to the at least one of the plurality of A-IoT devices via a Long Term Evolution Positioning Protocol (LPP) message.

In some examples, the backscatter configuration includes a reflection parameter configured by the network function for different ones of the plurality of A-IoT devices. Sending the backscatter configuration includes sending, by the network function to at least one of the plurality of BSs, the backscatter configuration via an NRPPa message, wherein the at least one of the plurality of BSs sends the backscatter configuration to the least one of the plurality of A-IoT devices via an RRC message. In some examples, the reflection parameter includes all transmit signal resource configuration parameters for the plurality of BSs, meaning that the LMF informs each BS not only the transmit signal resource configuration parameter of this BS, but also the transmit signal resource configuration parameter of other BSs which are covered by the LMF.

In some examples, a first A-IoT device of the plurality of A-IoT devices includes a Type A A-IoT device. The first A-IoT device reflects the signal received from a respective one of the plurality of BSs immediately in response to receiving the signal.

In some examples, a second A-IoT device of the plurality of A-IoT devices includes a Type B A-IoT device or a Type C A-IoT device, the second A-IoT device stores a received energy of the signal received from a respective one of the plurality of BSs and reflects the signal in response to reaching an energy threshold for reflecting the signal.

In some examples, in response to receiving the transmit signal configuration list, each of at least one of the plurality of BSs determines the backscatter configuration applicable to a cell of each of the at least one of the plurality of BSs. Each of the at least one of the plurality of BSs sends the backscatter configuration to the at least one of the plurality of A-IoT devices.

In some examples, the transmit signal configuration list is sent to a plurality of wireless communication devices (e.g., UEs). The backscatter configuration is determined and sent by at least one of the plurality of UEs the at least one of the plurality of A-IoT devices via sidelink. In some examples, the backscatter configuration is exchanged by the at least one of the plurality of wireless communication devices with other ones of the plurality of wireless communication devices via the sidelink.

In some examples, the backscatter configuration is determined by each of the at least one of the plurality of A-IoT devices. The at least one of the plurality of A-IoT devices sends the backscatter configuration to at least one of the plurality of BSs in an RRC message or to the network function in an LPP message.

In some examples, the at least one of the plurality of A-IoT devices generates and reports the backscatter configuration independently. Each of the at least one of the plurality of A-IoT devices includes a Type C A-IoT device.

In some arrangements, backscatter for transmissions modifies the characteristic of received signal from the BS/UE and reflects the received signal after processing. In some arrangements as described herein, reflection signal can be processed in spatial/time/frequency/code aspects. Some arrangements relate to the spatial processing which is applicable for A-IoT devices reflection signal.

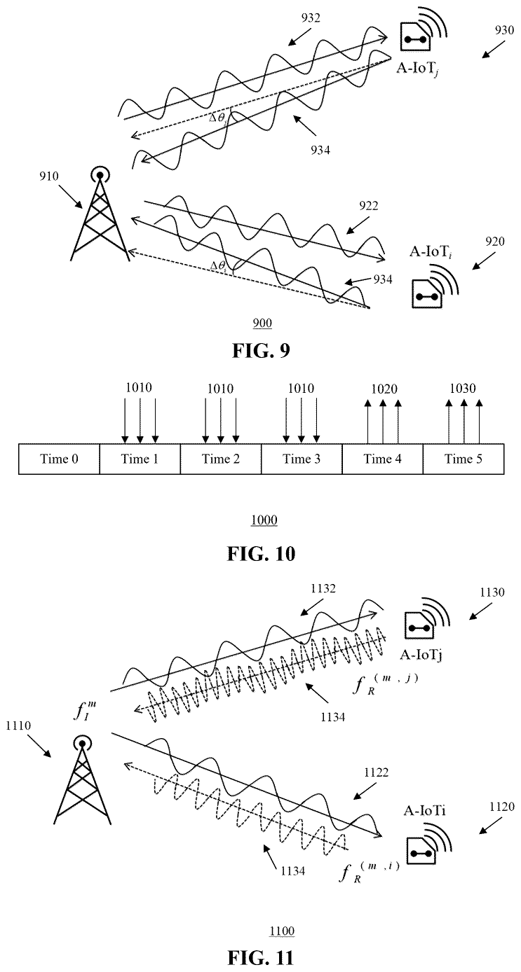

FIG. 9 is a diagram illustrating reflected signals in a spatial aspect (e.g., in a spatial domain), according to various arrangements. As shown in FIG. 9, the A-IoTᵢ 920 and A-IoTⱼ 930 backscatters the received signal 922 and 932 transmitted from the network node 910 respectively to generate the backscatter (reflected signal) 924 and 934, respectively, with a different additional angle offsets, which are Δθᵢ and Δθⱼ respectively. The reflection signal (e.g., spatial/time/frequency/code) resource configuration described herein can be a set of backscatter angle parameters such as a set of angle offsets to be backscattered, a backscatter angle offset, or so on.

In some arrangements, the set of angle offsets to be backscattered provides the candidates angle offset list for A-IoT devices to backscatter. The backscatter angle offset indicates the A-IoT device to backscatter the received signal in a specific angle, which is provided with an additional offset mechanism. Considering the requirement of directional antenna, the spatial processing may be merely applicable for Type B/C A-IoT devices.

In some arrangements, a network node receives a first backscatter reflected by a first A-IoT device of the at least one of the plurality of A-IoT devices with a first angle offset and a second backscatter reflected by a second A-IoT device of the at least one of the plurality of A-IoT devices with a second angle offset. The backscatter configuration includes a set of backscatter angle parameters. The set of backscatter angle parameters includes at least a set of angle offsets to be backscattered or a backscatter angle offset.

In some arrangements, the reflection time can be used to distinguish different A-IoT devices. FIG. 10 is a diagram illustrating A-IoT devices (e.g., A-IoTᵢ 920 and A-IoTⱼ 930) receiving the transmitted signal 1010 and reflect as reflected signal (backscatter) 1020 and 1030 at different times configured by the reflection signal (e.g., time/frequency/code/phase) resource configuration parameter in a reflection time method 1000, according to various arrangements. As shown, the A-IoTᵢ and A-IoTⱼ (e.g., those shown in FIG. 9) receive signals 1010 from a network node (e.g., a BS, a UE, and so on) at Time 1, Time 2, and Time 3. The A-IoTᵢ reflects the transmitted signals 1010 as reflected signals 1020 at Time 4. The A-IoTⱼ reflects the transmitted signals 1010 as reflected signals 1030 at Time 5. Accordingly, A-IoTᵢ and A-IoTⱼ reflect the signals with delayed reaction and at different response times. Compared to other processing method, this method 1000 does not need to change the waveform of the received signal. When configuring reflection time for different A-IoT devices, the configured reflection time is determined to be sufficient for each A-IoT device to obtain sufficient energy to reflect the transmitted signals 101. The reflection signal (e.g., spatial/time/frequency/code) resource configuration parameter described herein can include a set of reflection parameters such as a set of time to be backscattered, backscatter time, a set of energy thresholds, a set of energy thresholds offset, or so on.

In some arrangements, the set of time to be backscattered provides the candidate time for A-IoT devices to reflect. The backscatter time indicates the A-IoT devices to reflect the received signal at a specific time. The set of energy thresholds ensure different A-IoT devices can reflect at different times. For example, both A-IoTᵢ and A-IoTⱼ receive signal 1010 at Time1, but the threshold for A-IoTᵢ may be Eᵢ and the threshold for A-IoTⱼ may be Eⱼ. Therefore, A-IoTᵢ and A-IoTⱼ reach their respective thresholds and reflect at Time 4 and Time 5, respectively. The reflection time can also be determined according to a set of energy thresholds offsets, which provides the increasing energy offset. For example, for A-IoTᵢ, the energy threshold can be determined using:

$${E}_{i} = {E}_{0} + Δ E ; \qquad ( 1 )$$

and for A-IoTⱼ the energy threshold may be

$${E}_{i} = {E}_{0} + 2 Δ E , \qquad ( 2 )$$

where the energy threshold offset nΔE can be configured by the LMF, a BS, or a UE in for Type A/B A-IoT device or be reported by type C A-IoT devices.

In some arrangements, a network node (e.g., a UE or a BS) receives a first backscatter reflected by a first A-IoT device of the at least one of the plurality of A-IoT devices at a first reflection time and a second backscatter reflected by a second A-IoT device of the at least one of the plurality of A-IoT devices at a second reflection time. The backscatter configuration includes a set of energy threshold offsets. The first reflection time and second reflection time are determined according to the set of energy threshold offsets.

In some arrangements, the received signal can be characterized by a center frequency. By shifting the center frequency, different A-IoT devices can be distinguished under ultra-low power consumption. FIG. 11 is a diagram illustrating reflected signals a frequency domain for identifying A-IoTᵢ 1120 and A-IoTⱼ 1130 using center frequency shifting 1100, according to various arrangements. As shown in FIG. 11, the A-IoTᵢ 1120 and A-IoTⱼ 1130 backscatters the received signal 1122 and 1132 (transmitted from the network node 1110) respectively to generate the backscatter (reflected signal) 1124 and 1134, respectively.

In some examples, the backscatter (e.g., time/frequency/code/phase) resource configuration described herein can include a set of frequency reflection parameters such as a set of frequencies to be backscattered, backscatter frequency, set of frequency offset to be backscattered, a backscatter frequency offset, a number of frequency (or frequency offset) to be backscattered, a carrier frequency spacing, or another suitable parameter.

In some arrangements, the set of frequencies to be backscattered provides the candidate frequency list for A-IoT devices to reflect. The backscatter frequency indicates the A-IoT devices to reflect the received signal with a specific center frequency. The set of frequency offsets to be backscattered and the backscatter frequency offset can indicate the A-IoT devices to reflect the received signal with a certain frequency. In some examples, the backscatter frequency may indicate the absolute center frequency and the backscatter frequency offset can indicate the center relative frequency, such as using:

$${f}_{R}^{( m , i )} = {f}_{I}^{m} + Δ {f}^{i} ; \qquad ( 3 )$$

$${f}_{R}^{( m , j )} = {f}_{I}^{m} + Δ {f}^{j} ; \qquad ( 4 )$$

where Δfⁱ and Δf^{j} are the reflection parameters which can be configured by the LMF, a BS, or a UE, or reported by the A-IoT device itself.

As for the number of frequencies (or frequency offsets) to be backscattered, if the A-IoT device is configured with a set of reflect frequency (offset) candidates, the A-IoT device can select one or more frequencies (or frequency offsets) from the candidate set. If the processing parameters specify the number of frequencies (or frequency offsets) (for example, if the parameters is equal to 2), the A-IoT device selects two frequencies (or frequency offsets) from the candidate set.

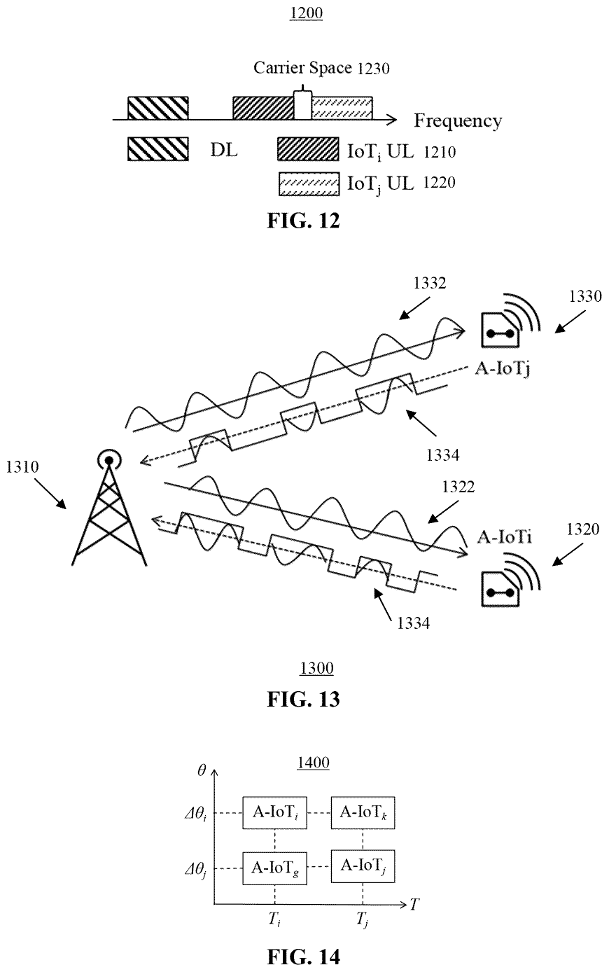

In some examples, the sub-carriers of the reflected signals generated by A-IoT devices are square waves, which have spectral leakage in the frequency domain, resulting in interference among A-IoT devices. Similar to the Sub Carrier Spacing (SCS) in NR, carrier frequency space is a reflection parameter limiting the minimum frequency gap between different A-IoT devices, to reduce the frequency interference of different A-IoT devices. FIG. 12 is a diagram illustrating an example carrier space 1230 for center frequency shifting, according to various arrangements. In the frequency domain, uplink frequency resources 1210 and 1220 for A-IoTᵢ 1120 and A-IoTⱼ 1130 are separated by the carrier space 1230, to reduce the interference between A-IoTᵢ 1120 and A-IoTⱼ 1130.

In some arrangements, a network node receives a first backscatter reflected by a first A-IoT device of the at least one of the plurality of A-IoT devices using a first center frequency and a second backscatter reflected by a second A-IoT device of the at least one of the plurality of A-IoT devices using a second center frequency. The backscatter configuration comprises at least one of a set of frequencies to be backscattered, a backscatter frequency, a set of frequency offsets to be backscattered, a backscatter frequency offset, a number of frequencies or frequency offsets to be backscattered, or a carrier frequency spacing.

In some arrangements, the first center frequency and the second center frequency are shifted using respective absolute values. In some arrangements, the first center frequency and the second center frequency are shifted using respective relative offsets with respect to a center frequency of the transmitted signal. In some arrangements, the carrier frequency spacing reduces an interference between the first A-IoT device and the second A-IoT device.

In some arrangements, based on the envelope detection, the A-IoT devices can be processed in code field to distinguish different A-IoT devices. To reduce implementation complexity, On Off Keying (OOK) code can be used for A-IoT device identification. FIG. 13 is a diagram illustrating reflected signals in a code domain for identifying A-IoTᵢ 1320 and A-IoTⱼ 1330 using OOK code method 1300, according to various arrangements. As shown in FIG. 13, the A-IoTᵢ 1320 and A-IoTⱼ 1330 backscatters the received signal 1322 and 1332 transmitted by the network node 1310, respectively to generate the backscatter (reflected signal) 1324 and 1334, which are square waves, respectively.

As shown in FIG. 13, the A-IoTᵢ 1320 and A-IoTⱼ 1330 receive the transmitting signal 1322 and 1332, respectively, and reflect within different OOK code. For A-IoTᵢ 1320, the OOK code may be “1001011”, and for A-IoTⱼ 1330, the OOK code may be “1101101”. The reflection signal (spatial/time/frequency/code) resource configuration can include a set of parameters such as one or more of an encoding rule, a backscatter OOK code, a Pulse Width (PW), a signal level threshold, or another suitable parameter.

The encoding rule provides candidate amplitude OOK processing way for different A-IoT devices. The backscatter OOK code indicates the certain OOK code which is associated to A-IoT ID. The PW and signal level threshold are parameters for OOK.

In some arrangements, a network node receives a first backscatter reflected by a first A-IoT device of the at least one of the plurality of A-IoT devices using a first On Off Keying (OOK) code and a second backscatter reflected by a second A-IoT device of the at least one of the plurality of A-IoT devices using a second OOK code. The backscatter configuration comprises at least one of an encoding rule, a backscatter OOK code, a Pulse Width (PW), a signal level threshold, or another suitable parameter.

In some arrangements, in order to reduce the resource consumption and identification aliasing of A-IoT devices during multi-user multiplexing, received signal can be joint-processed based on the processing methods described herein for the spatial domain, time domain, frequency domain, and code domain. FIG. 14 is a diagram illustrating a joint processing method 1400 based on the time domain (T) and the spatial domain (θ), according to various arrangements.

As shown in FIG. 14, the received signal can be processed in spatial domain and time domain together. Specifically, for A-IoTᵢ, the spatial-time configuration of the reflection signal is (Timeᵢ, Δθᵢ), for A-IoTⱼ, the spatial-time configuration of the reflection signal is (Timeⱼ, Δθⱼ), for A-IoT_{g}, the spatial-time configuration of the reflection signal is (Timeᵢ, Δθⱼ), and for A-IoTₖ, the spatial-time configuration of the reflection signal is (Timeⱼ, Δθᵢ).

In some arrangements, the received signal can be joint-processed in the spatial domain and the frequency domain. Specifically, for A-IoTᵢ, the spatial-frequency configuration of the reflection signal is (Frequencyᵢ, Δθᵢ), for A-IoTⱼ, the spatial-frequency configuration of the reflection signal is (Frequencyⱼ, Δθⱼ), for A-IoT_{g}, the spatial-frequency configuration of the reflection signal is (Frequencyᵢ, Δθⱼ), and for A-IoTₖ, the spatial-frequency configuration of the reflection signal is (Frequencyⱼ, Δθᵢ).

In some arrangements, the received signal can be joint-processed in the spatial domain and the code domain. Specifically, for A-IoTᵢ, the spatial-code configuration of the reflection signal is (Codeᵢ, Δθᵢ), for A-IoTⱼ, the spatial-code configuration of the reflection signal is (Codeⱼ, Δθⱼ), for A-IoT_{g}, the spatial-code configuration of the reflection signal is (Codeᵢ, Δθᵢ), and for A-IoTₖ, the spatial-code configuration of the reflection signal is (Codeⱼ, Δθᵢ). The code can be OOK codes as described herein.

In some arrangements, the received signal can be joint-processed in the time domain and the frequency domain. Specifically, for A-IoTᵢ, the time-frequency configuration of the reflection signal is (Frequencyᵢ, Timeᵢ), for A-IoTⱼ, the time-frequency configuration of the reflection signal is (Frequencyⱼ, Timeⱼ), for A-IoT_{g}, the time-frequency configuration of the reflection signal is (Frequencyᵢ, Timeᵢ), and for A-IoTₖ, the time-frequency configuration of the reflection signal is (Frequencyⱼ, Timeᵢ).

In some arrangements, the received signal can be joint-processed in the frequency domain and the code domain. Specifically, for A-IoTᵢ, the frequency-code configuration of the reflection signal is (Codeᵢ, Frequencyᵢ), for A-IoTⱼ, the frequency-code configuration of the reflection signal is (Codeⱼ, Frequencyⱼ), for A-IoT_{g}, the frequency-code configuration of the reflection signal is (Codeᵢ, Frequencyᵢ), and for A-IoTₖ, the frequency-code configuration of the reflection signal is (Codeⱼ, Frequencyⱼ). The code can be OOK codes as described herein.

In some arrangements, the received signal can be joint-processed in the time domain and the code domain. Specifically, for A-IoTᵢ, the time-code configuration of the reflection signal is (Codeᵢ, Timeᵢ), for A-IoTⱼ, the time-code configuration of the reflection signal is (Codeⱼ, Timeⱼ), for A-IoT_{g}, the time-code configuration of the reflection signal is (Codeᵢ, Timeⱼ), and for A-IoTₖ, the time-code configuration of the reflection signal is (Codeⱼ, Timeᵢ). The code can be OOK codes as described herein.

In some arrangements, a network node receives the backscatter reflected by two or more of the plurality of A-IoT devices, and the network node jointly processes the backscatter in two or more of a spatial domain, a time domain, a frequency domain, or a code domain.

In some arrangements, in RFID, the bandwidth supported by terminal devices may be only at the hundred-KHz level, which can obtain the tag information but not sufficient for positioning. Although bandwidth independent positioning method such as CPP has been studied for many occasions, performance degradation in absence of prior knowledge still exist. In some arrangements, there can be two sets of reflection parameters which are applicable for communication or positioning respectively.

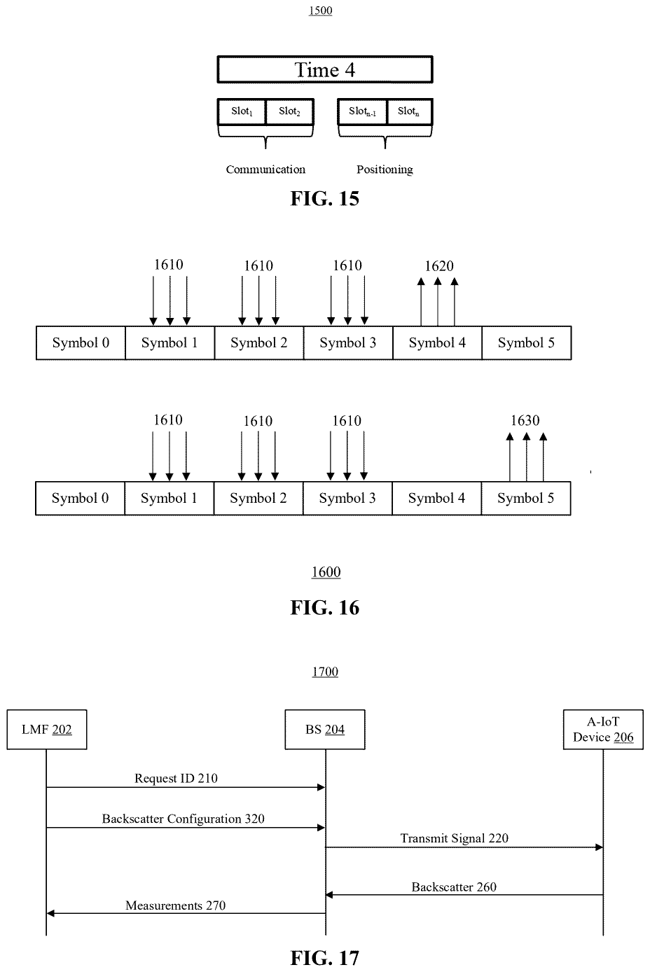

FIG. 15 is a diagram illustrating an example method 1500 for configuring communication and positioning reflection parameters separately, according to various arrangements. As shown in FIG. 15, an A-IoTᵢ device reflects in Time 4. The A-IoTᵢ device reflects for communication in slot₁ and slot₂, and reflects for positioning in slotₙ₋₁ and slotₙ. Accordingly, signals for communication and signals for positioning can be reflected in different time-domain resources.

In some examples, the configuration time granularity can also be greater or lesser. FIG. 16 is a diagram illustrating an example method 1600 for configuring communication and positioning reflection parameters separately, according to various arrangements. As shown in FIG. 16, the A-IoTᵢ device reflects for communication (e.g., communication reflected signals 1620) in Symbol 4 and reflects for positioning (e.g., positioning reflected signals 1620) in Symbol 5, in response to receiving signals 1610 transmitted by a network node (e.g., a BS, a UE, or so on). In other words, communication and positioning reflection parameters are configured at the symbol level.

For communication purpose, the A-IoT device reflects the received signal 1610 in a narrow band. For positioning purpose, in order to ensure the positioning accuracy, the A-IoT device reflects the received signal 1610 without bandpass filtering.

In some arrangements, the backscatter configuration includes a first reflection parameter for reflecting the signal for communication and a second reflection parameter for reflecting the signal for positioning. A network node receives a first backscatter corresponding to the signal for the communication in a narrow band. The network node receives a second backscatter corresponding to the signal for the positioning without bandpass filtering.

In some arrangements, distinguishing different A-IoT devices can based on the backscatter configuration. Specifically, the LMF, BS, or UE can determine the relation of the A-IoT ID and the reflection signal (e.g., spatial/time/frequency/code) resource configuration parameter which needs a previous estimation of the number of the A-IoT devices appearing in the cells.

In some examples, the backscatter configuration can only configure the processing or modulation method. The information about the ID is carried by the A-IoT device(s) itself and set up Ex-factory.

FIG. 17 is a signaling diagram illustrating an example method 1700 for configuring communications of an A-IoT device 206, according to various arrangements. While FIG. 17 shows one BS 204 and one A-IoT device 206, the method 1700 can be implemented for multiple BSs (each of which can be the BS 204) and A-IoT devices (each of which can be the A-IoT device 206). The method 1700 relates to reflection parameters for only the processing method is configured by the LMF 202.

As described with respect to FIG. 2, at 210, the LMF 202 sends a request ID message to each of a plurality of BSs (e.g., the BS 204). At 320, the LMF 202 can send the backscatter configuration to the plurality of BSs (e.g., the BS 204) via an NRPPA message.

As described with respect to FIG. 2, at 220, each of the plurality of BSs (e.g., the BS 204) transmits a signal (e.g., a measurement signal or a signal to be measured) to each of a plurality of A-IoT devices (e.g., the A-IoT device 206). As described with respect to FIG. 2, at 260, the A-IoT device 206 can send the backscatter (e.g., the reflected signal) to the BS 204. As described with respect to FIG. 2, at 270, the BS 204 sends to the LMF 202 the measurements of the backscatter (e.g., the reflected signal).

In the method 1700, the LMF 202 can determine the time/frequency resource configuration of all signals transmitted by the BS 204 and the spatial/time/frequency/code resource configuration of all signals reflected by A-IoT devices. In some examples, the backscatter configuration sent by the LMF 202 contains information for only the processing method, e.g., the center frequency shifting and/or OOK. The A-IoT device 206 reflects the received signal and carry its sequence ID which is predetermined. In the method 1700, the A-IoT device 206 reports its own reflection parameters. In the method 1700, the backscatter configuration can also include the cell ID of the BS 204 which can report a group information of the A-IoT devices covered.

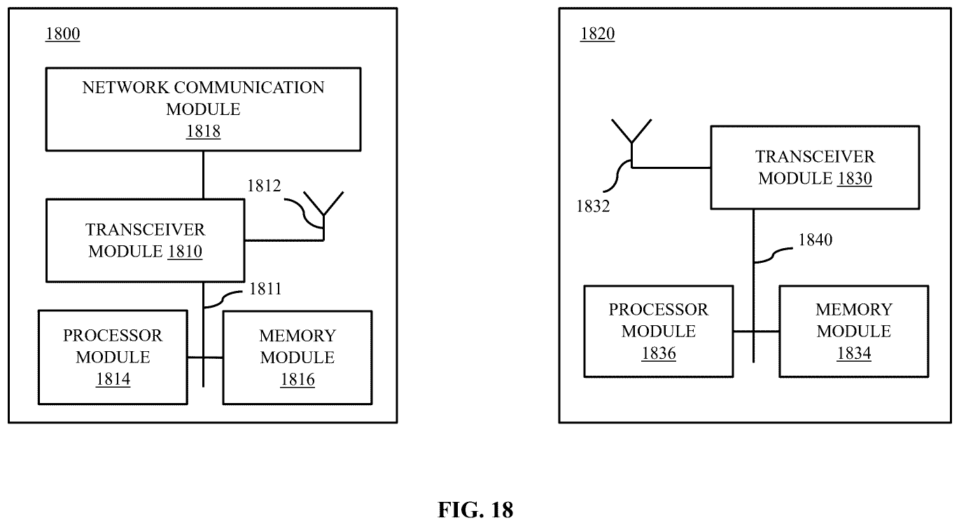

FIG. 18 illustrates a block diagram of an example BS 1800 and an example UE 1820, according to various arrangements. The BS 1800 is a network node such as an evolved node B (eNB), g Node B (gNB), a femto station, a pico station, Reconfigurable Intelligent Surface (RIS), relay node, Integrated Access and Backhaul (IAB) node, Network Controlled Repeater (NCR) node, and so on. The BS 1800 includes a transceiver module 1810, an antenna 1812, a processor module 1814, a memory module 1816, and a network communication module 1818, each module being coupled and interconnected with one another as necessary via a data communication bus 1811. The UE 1820 (e.g., a wireless communication device) includes a transceiver module 1830, an antenna 1832, a memory module 1834, and a processor module 1836, each module being coupled and interconnected with one another as necessary via a data communication bus 1840. The BS 1800 communicates with the UE 1820 via a communication channel, link, connection, or beam, which can be any wireless channel or other medium suitable for transmission of data as described herein.

In some arrangements, the backscatter configuration includes an indicator and a cell ID. The indicator indicates to the at least one of the plurality of A-IoT devices to backscatter the signal using one of method a time-domain method, a frequency-domain method, or a code-domain method). A parameter indicating the method is determined a sequence ID carried by the at least one of the plurality of A-IoT devices. The cell ID is used to report group information of the at least one of the plurality of A-IoT devices covered by the network node.

As would be understood by persons of ordinary skill in the art, the BS 1800 and the UE 1820 can further include any number of modules other than the modules shown in FIG. 18. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the transceiver 1830 can be referred to herein as an uplink transceiver 1830 that includes a radio frequency (RF) transmitter and a RF receiver each including circuitry that is coupled to the antenna 1832. A duplex switch (not shown) may alternatively couple the uplink transmitter or receiver to the uplink antenna in time duplex fashion. Similarly, in accordance with some implementations, the transceiver 1810 may be referred to herein as a downlink transceiver 1810 that includes a RF transmitter and a RF receiver each including circuitry that is coupled to the antenna 1812. A downlink duplex switch may alternatively couple the downlink transmitter or receiver to the downlink antenna 1812 in time duplex fashion. The operations of the two transceiver modules 1810 and 1830 can be coordinated in time such that the uplink receiver circuitry is coupled to the uplink antenna 1832 for reception of transmissions over the wireless transmission link at the same time that the downlink transmitter is coupled to the downlink antenna 1812. In some implementations, there is close time synchronization with a minimal guard time between changes in duplex direction.

The transceiver 1830 and the transceiver 1810 are configured to communicate via the wireless data communication link (e.g., channels, connections, and beams), and cooperate with a suitably configured RF antenna arrangement 1812/1832 that can support a particular wireless communication protocol and modulation scheme. In some illustrative implementations, the transceiver 1810 and the transceiver 1830 are configured to support industry standards such as the Long Term Evolution (LTE) and emerging 5G/6G standards, and the like. It is understood, however, that the present disclosure is not necessarily limited in application to a particular standard and associated protocols. Rather, the transceiver 1830 and the transceiver 1810 may be configured to support alternate, or additional, wireless data communication protocols, including future standards or variations thereof.

In some implementations, the UE 1820 can be various types of message clients such as a mobile phone, a smart phone, a personal digital assistant (PDA), tablet, laptop computer, wearable computing device, etc. The processor modules 1814 and 1836 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be implemented directly in hardware, in firmware, in a software module executed by processor modules 1814 and 1836, respectively, or in any practical combination thereof. The memory modules 1816 and 1834 may be realized as RAM memory, flash memory, ROM memory, EPROM memory, EEPROM memory, registers, a hard disk, a removable disk, a CD-ROM, or any other form of storage medium known in the art. In this regard, memory modules 1816 and 1834 may be coupled to the processor modules 1814 and 1836, respectively, such that the processors modules 1814 and 1836 can read information from, and write information to, memory modules 1816 and 1834, respectively. The memory modules 1816 and 1834 may also be integrated into their respective processor modules 1814 and 1836. In some implementations, the memory modules 1816 and 1834 may each include a cache memory for storing temporary variables or other intermediate information during execution of instructions to be executed by processor modules 1814 and 1836, respectively. Memory modules 1816 and 1834 may also each include non-volatile memory for storing instructions to be executed by the processor modules 1814 and 1836, respectively.

The network communication module 1818 generally represents the hardware, software, firmware, processing logic, and/or other components of the BS 1800 that enable bi-directional communication between transceiver 1810 and other network components and communication nodes (e.g., another node such as the BS 1800) configured to communicate with the BS 1800. For example, network communication module 1818 may be configured to support internet or WiMAX traffic. In a typical deployment, without limitation, network communication module 1818 provides an 802.3 Ethernet interface such that transceiver 1810 can communicate with a conventional Ethernet based computer network. In this manner, the network communication module 1818 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

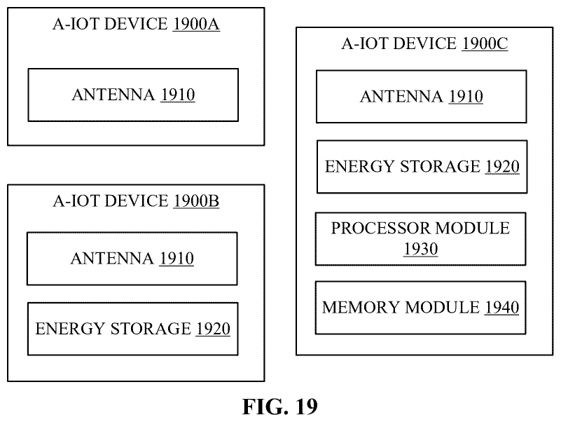

FIG. 19 illustrates block diagram of example A-IoT devices 1900A, 1900B, and 1900C, according to various arrangements. In some examples, the A-IoT device 1900A is a Type A A-IoT device. The A-IoT device 1900A includes an antenna 1910 such as the antenna 1812 or 1832. In some examples, the antenna 1910 can include a reflective surface, an antenna array, and so on that can reflect a signal as reflected signal or backscatter, as described. In some examples, the A-IoT device 1900B is a Type B A-IoT device. In some examples, the antenna 1910 is coupled to an envelope detector module, which is coupled to a power excitation module and a modulator module.

The A-IoT device 1900B includes the antenna 1910 and an energy storage 1920. The energy storage 1920 can be a battery, power interface, capacity and so on. In some examples, the antenna 1910 is coupled to an envelope detector module. The energy storage 1920 can be managed by a power management module. In some examples, the A-IoT device 1900B includes a processor module (e.g., such as the processor module 1814 or 1836) that controls an amplifier module configured to amplify the received and/or reflected signal.

In some examples, the A-IoT device 1900C is a Type C A-IoT device. The A-IoT device 1900C includes the antenna 1910, the energy storage 1920, and a processor module 1930 and a memory module 1940. The processor module 1930 can be a module such as the processor module 1814 or 1836. The memory module 1834 can be a module such as the memory module 1816 or 1834. In some examples, the antenna 1910 is operatively coupled to a transceiver module (such as the transceiver module 1810 or 1830), which in turn is coupled to the processor module 1930 and the memory module 1940. The energy storage 1920 can be managed by a power management module.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method, comprising:
receiving, by a network function from each of a plurality of Base Stations (BSs), transmit signal configuration for a signal transmitted by each of the plurality of BSs to a respective one of a plurality of Ambient power-enabled Internet of Things (A-IoT) devices;
sending, by the network function, a transmit signal configuration list comprising the transmit signal configuration received from each of the plurality of BSs; and
sending, to at least one of the plurality of A-IoT devices, backscatter configuration indicating a mapping relationship between the signal received by the at least one of the plurality of A-IoT devices and a backscatter reflected by the at least one of the plurality of A-IoT devices.

2. The method of claim 1, wherein
the backscatter configuration comprises a reflection parameter configured by the network function for different ones of the plurality of A-IoT devices; and
the backscatter configuration being sent by the network function to the at least one of the plurality of A-IoT devices via a Long Term Evolution Positioning Protocol (LPP) message.

3. The method of claim 1, wherein
the backscatter configuration comprises a reflection parameter configured by the network function for different ones of the plurality of A-IoT devices; and
sending the backscatter configuration comprises:
sending, by the network function to at least one of the plurality of BSs, the backscatter configuration via a New Radio Positioning Protocol A (NRPPa) message, wherein the at least one of the plurality of BSs sends the backscatter configuration to the least one of the plurality of A-IoT devices via a Radio Resource Control (RRC) message.

4. The method of claim 3, wherein the reflection parameter comprises all transmit signal resource configuration parameters for the plurality of BSs.

5. The method of claim 1, wherein a first A-IoT device of the plurality of A-IoT devices comprises a Type A A-IoT device, the first A-IoT device reflects the signal received from a respective one of the plurality of BSs immediately in response to receiving the signal.

6. The method of claim 1, wherein a second A-IoT device of the plurality of A-IoT devices comprises a Type B A-IoT device or a Type C A-IoT device, the second A-IoT device stores a received energy of the signal received from a respective one of the plurality of BSs and reflects the signal in response to reaching an energy threshold for reflecting the signal.

7. The method of claim 1, wherein
in response to receiving the transmit signal configuration list, each of at least one of the plurality of BSs determines the backscatter configuration applicable to a cell of each of the at least one of the plurality of BSs; and
each of the at least one of the plurality of BSs sends the backscatter configuration to the at least one of the plurality of A-IoT devices.

8. The method of claim 1, wherein
the transmit signal configuration list is sent to a plurality of wireless communication devices; and
the backscatter configuration is determined and sent by at least one of the plurality of wireless communication devices to the at least one of the plurality of A-IoT devices via sidelink.

9. The method of claim 8, wherein the backscatter configuration is exchanged by the at least one of the plurality of wireless communication devices with other ones of the plurality of wireless communication devices via the sidelink.

10. The method of claim 1, wherein
the backscatter configuration is determined by each of the at least one of the plurality of A-IoT devices, and the at least one of the plurality of A-IoT devices sends the backscatter configuration to at least one of the plurality of BSs in a Radio Resource Control (RRC) message or to the network function in Long Term Evolution Positioning Protocol (LPP) message.

11. The method of claim 10, wherein
the at least one of the plurality of A-IoT devices generates and reports the backscatter configuration independently; and
each of the at least one of the plurality of A-IoT devices comprises a Type C A-IoT device.

12. The method of claim 1, wherein
a network node receives a first backscatter reflected by a first A-IoT device of the at least one of the plurality of A-IoT devices with a first angle offset and a second backscatter reflected by a second A-IoT device of the at least one of the plurality of A-IoT devices with a second angle offset;
the backscatter configuration comprises a set of backscatter angle parameters, the set of backscatter angle parameters comprises at least a set of angle offsets to be backscattered or a backscatter angle offset.

13. The method of claim 1, wherein
a network node receives a first backscatter reflected by a first A-IoT device of the at least one of the plurality of A-IoT devices at a first reflection time and a second backscatter reflected by a second A-IoT device of the at least one of the plurality of A-IoT devices at a second reflection time;
the backscatter configuration comprises a set of energy threshold offsets, wherein the first reflection time and second reflection time are determined according to the set of energy threshold offsets.

14. The method of claim 1, wherein
a network node receives a first backscatter reflected by a first A-IoT device of the at least one of the plurality of A-IoT devices using a first center frequency and a second backscatter reflected by a second A-IoT device of the at least one of the plurality of A-IoT devices using a second center frequency;
the backscatter configuration comprises at least one of a set of frequencies to be backscattered, a backscatter frequency, a set of frequency offsets to be backscattered, a backscatter frequency offset, a number of frequencies or frequency offsets to be backscattered, or a carrier frequency spacing.

15. The method of claim 14, wherein
the first center frequency and the second center frequency are shifted using respective absolute values; or
the first center frequency and the second center frequency are shifted using respective relative offsets with respect to a center frequency of the transmitted signal.

16. The method of claim 14, wherein the carrier frequency spacing reduces an interference between the first A-IoT device and the second A-IoT device.

17. The method of claim 1, wherein
a network node receives a first backscatter reflected by a first A-IoT device of the at least one of the plurality of A-IoT devices using a first On Off Keying (OOK) code and a second backscatter reflected by a second A-IoT device of the at least one of the plurality of A-IoT devices using a second OOK code; and
the backscatter configuration comprises at least one of an encoding rule, a backscatter OOK code, a Pulse Width (PW), a signal level threshold, or another parameter.

18. A method, comprising:
sending, by a Base Station (BS) to a network function, transmit signal configuration for a signal transmitted by the BS to a respective one of a plurality of Ambient power-enabled Internet of Things (A-IoT) devices;
receiving, by the BS, a transmit signal configuration list comprising the transmit signal configuration received from each of a plurality of BSs; and
sending, by the BS to at least one of the plurality of A-IoT devices, backscatter configuration indicating a mapping relationship between the signal received by the at least one of the plurality of A-IoT devices and a backscatter reflected by the at least one of the plurality of A-IoT devices.

19. A network function, comprising:
at least one processor configured to:
receive, via a transceiver from each of a plurality of Base Stations (BSs), transmit signal configuration for a signal transmitted by each of the plurality of BSs to a respective one of a plurality of Ambient power-enabled Internet of Things (A-IoT) devices;
send, via the transceiver, a transmit signal configuration list comprising the transmit signal configuration received from each of the plurality of BSs; and
send, via the transceiver to at least one of the plurality of A-IoT devices, backscatter configuration indicating a mapping relationship between the signal received by the at least one of the plurality of A-IoT devices and a backscatter reflected by the at least one of the plurality of A-IoT devices.

20. A base station (BS), comprising:
at least one processor configured to:
send, via a transceiver to a network function, transmit signal configuration for a signal transmitted by the BS to a respective one of a plurality of Ambient power-enabled Internet of Things (A-IoT) devices;
receive, via the transceiver, a transmit signal configuration list comprising the transmit signal configuration received from each of a plurality of BSs; and
send, via the transceiver to at least one of the plurality of A-IoT devices, backscatter configuration indicating a mapping relationship between the signal received by the at least one of the plurality of A-IoT devices and a backscatter reflected by the at least one of the plurality of A-IoT devices.
